(19) United States
(12) Patent Application Publication
(10) Pub. No.: US 2009/0287609 A1
(43) Pub. Date: Nov. 19, 2009

(54) Method and system for managing projects over a network

(75) Inventors: Vivek Sharma, Haryana (IN); Varun Sharma, Haryana (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Ltd., Bangalore (IN)

(21) Appl. No.: 12/316,373

(22) Filed: Dec. 11, 2008

(30) Foreign Application Priority Data
Dec. 13, 2007 (IN) 2987/CHE/2007

(51) Int. Cl. G06Q 10/00; G06Q 30/00

(52) U.S. Cl. 705/80; 705/400; 705/26; 705/9

(57) ABSTRACT

A method and system for managing projects on a network platform that enables a buyer to make a buy request for a project on a network platform. The buy request includes various requirements of the project. In response to the buy request, various sellers provide submissions for the project on the network platform. The submissions may be utilized by the buyer of the project. Various sellers can provide the submissions that comply with one or more requirements of the project. The buyer utilizes the submissions to execute the project, based on their compliance with the requirements of the project, and provides compensation to the sellers.

### BACKGROUND OF THE INVENTION

The present invention relates to the field of project management. More specifically, the present invention relates to a method and system for managing projects on a network platform.

With the rapid growth of organizations across the world, the demand for executing a wide variety of technology intensive projects within strict time lines is increasing exponentially. Today, the competitive environment demands the organizations to provide services in competitive packages and budget. To meet these demands, a project requires internal planning, resource allocation and execution to effectively manage and conclude projects, to completion. Organizations are facing problems in optimization due to the high cost of executing projects, the availability of resources to execute the project from its inception to its completion, heavy overheads, and the like. Organizations are falling short of resources, skilled workforce and infrastructure, required to fulfill the requirements of projects that need to be conducted within a limited time frame and a reasonable budget.

Today, organizations prefer to outsource their project requirements to technically skilled external service providers, so that the internal pressure on employees to execute and complete projects is reduced. The use of a network platform for managing projects enables organizations to easily contact such skilled external service providers.

Various methods have been proposed for managing projects through a network platform. One of the methods requires a buyer to search for sellers through this platform. The buyer contacts the sellers through meetings and telephonic calls to discuss the requirements of the projects. The buyers are also required to sign a contract with the seller that pertains to their fulfilling the requirements of the projects. The method however involves a significant amount of in-person dealing between the buyers and the sellers, which increases the cost of and time required for the project. Further, contracts that bind buyers and relate to the completion of the projects and execution-in-part are not acceptable in this method.

Another method for managing projects involves a buyer making a request related to the requirements of a project on the network platform. In this method, individuals with information about the requirements of the project can share their knowledge with the buyer. The method enables these individuals to share their knowledge with the buyer. However, the method does not require these individuals to be involved in the execution of the project. Further, there is no mechanism that enables the determination of the compensation to be paid to such individuals for the information provided by them.

In light of the above, there is a need for a method for managing the projects on a network platform with minimal in-person interaction between the buyers and the sellers. Further, there is a need for a method that enables sellers to provide their services without entering any contractual agreement with the buyers. The sellers should get the requisite compensation for the services provided by them.

There is also a need for a method that enables buyers to reduce the execution time of the project by the contribution made by the sellers.

### BRIEF SUMMARY OF THE INVENTION

An objective of the invention is to provide a method and system for efficiently managing projects on a network platform.

Another objective of the invention is to provide a method that enables various sellers to provide submissions for a project without having any contractual interactions with a buyer.

Another objective of the invention is to provide a fair compensation to the sellers for these submissions.

Another objective of the invention is to enable the sellers to share their existing knowledge and provide the existing knowledge that is suitable for the execution of the project.

Yet another objective of the invention is to execute the project in the minimum amount of time, maintaining quality standards while executing the project.

To achieve the objectives mentioned above, the invention provides a method and system for managing projects on the network platform. The method requires a buyer to make a request for the project on the network platform. The request includes the requirements of the project. In response to the request, sellers provide submissions for the project on the network platform. These submissions comply with the requirements of the project. The submissions submitted by the sellers are evaluated by an evaluator, on the basis of the requirements of the project. The buyer receives the submissions and the evaluations for the submissions on the network platform and then determines the compensation for the sellers, on the basis of the submissions and the evaluations. The sellers are compensated for their services, and the submissions are utilized by the buyer in the execution of the project.

In accordance with another embodiment of the invention, sellers provide proposals for the project, in response to a request. These proposals include at least a bid for the project. The buyer and the sellers then enter an agreement on the basis of the proposals and the bid. The sellers have resources to provide submissions for the project. These resources comply with the requirements of the project and the sellers utilize the resources to submit the submissions for the project to the buyer. The buyer then determines the compensation for the sellers, on the basis of the submissions and the agreements.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram illustrating an environment in which various embodiments of the present invention may be practiced;

FIG. 2 is a flowchart depicting a method for managing a project on a network platform, in accordance with one embodiment of the invention;

FIG. 3 is a flowchart depicting a method for managing a project on the network platform, in accordance with another embodiment of the invention;

FIG. 4 is a flowchart depicting a method for managing a project on the network platform, in accordance with yet another embodiment of the invention;

FIG. 5 is a block diagram illustrating the functional modules of a system, in accordance with one embodiment of the invention; and

FIG. 6 is a block diagram illustrating the functional modules of a system, in accordance with another embodiment of the invention.

### DETAILED DESCRIPTION

Various embodiments of the invention provide a method and system for managing projects over a network. The method provides an engagement framework for managing the projects over a network platform to various buyers and sellers. The projects are managed by various buyers, who make a buy request relating to the project to various sellers through the network platform. The network platform provides an interface for providing buy requests for projects from various buyers to the sellers, and accepting submissions from the various sellers for the projects, on the basis of the buy requests. These submissions are utilized by the buyers to execute the projects.

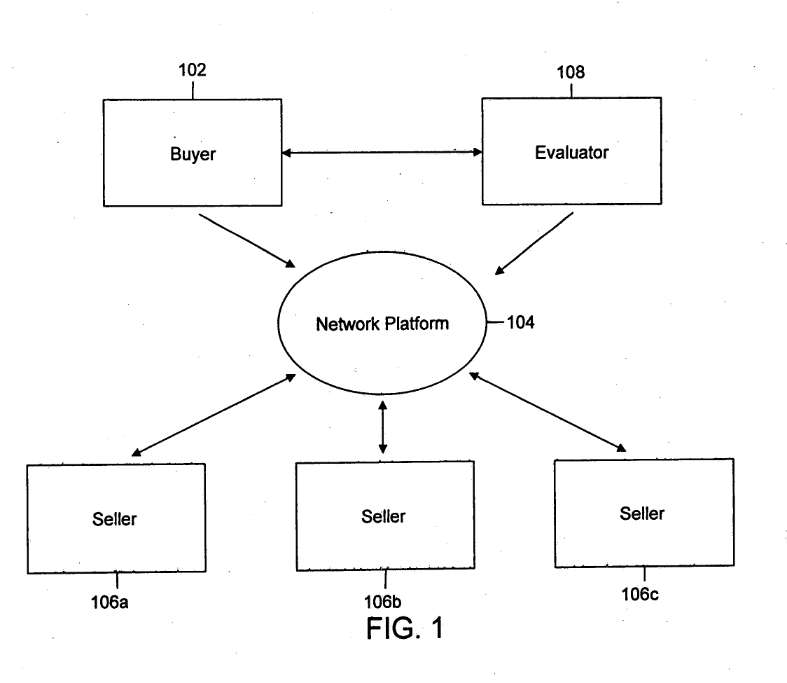

FIG. 1 is a block diagram illustrating an environment 100 in which various embodiments of the present invention may be practiced. Environment 100 includes a buyer 102, a network platform 104, seller 106a, 106b and 106c, hereinafter referred to as sellers 106, and an evaluator 108.

Environment 100 enables buyer 102 to manage a project through network platform 104. Buyer 102 initiates the project by providing a buy request for the project on network platform 104. This buy request includes various requirements of the project. In various embodiments of the invention, buyer 102 may be a project owner, an individual requester, an organization, a service provider, a division in the organization, a set of professionals, and the like.

Network platform 104 enables buyer 102 to initiate the project and receive submissions for the project from sellers 106. In various embodiments of the invention, network platform 104 may be a web portal, a portal hosted on a server, a network based interface, and the like. Network platform 104 is managed by an administrator. Examples of the administrator include, but are not limited to, a network platform owner, an organization, an individual, and the like. In one embodiment of the invention, network platform 104 may be administered by buyer 102. Hence, network platform 104 is customized and controlled by buyer 102, depending on the specific requirements of the projects requested by buyer 102. In another embodiment of the invention, buyer 102, sellers 106 and evaluator 108 may access network platform 104 directly. In yet another embodiment of the invention, buyer 102, sellers 106 and evaluator 108 have restricted access to network platform 104.

Sellers 106 provide the submissions for the project on network platform 104, on the basis of the buy request. In various embodiments of the invention, sellers 106 have the required resources to provide submissions for the project. In various embodiments of the invention, sellers 106 may be an organization, a division in the organization, an employee in the organization, a firm providing services, a group of professionals, an individual, and the like.

Evaluator 108 evaluates the submissions submitted on network platform 104, based on the fulfillment of the buy request, and provides the evaluations for the submissions to buyer 102 through network platform 104. In various embodiments of the invention, evaluator 108 may be an expert, an analyst, an external organization, a group of professionals, an individual, and the like. Evaluator 108 provides credibility and authenticity to buyer 102 and the compensation declared by buyer 102. In an alternative embodiment of the invention, buyer 102 may play the role of evaluator 108. In another embodiment of the invention, the administrator may play the role of evaluator 108.

The submissions are used by buyer 102 to complete the project. Further, buyer 102 compensates sellers 106, based on the submissions received from them. In one embodiment of the invention, the evaluation is taken into consideration while deciding on the compensation to be paid to sellers 106.

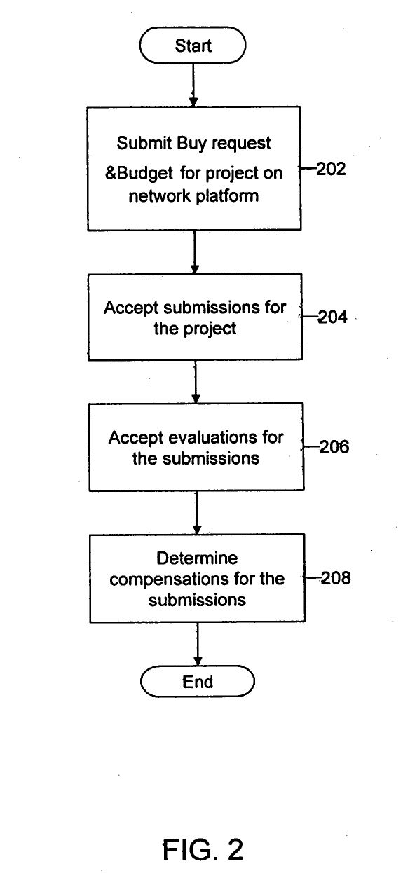

FIG. 2 is a flowchart depicting a method for managing the project on network platform 104, in accordance with one embodiment of the invention.

At 202, buyer 102 submits a buy request for the project on network platform 104. The buy request includes various requirements of the project. Examples of the requirements include, but are not limited to, the technical domain of the project, the details of the project, the objective of the project, the time line of the project, the type of a submission expected for the project, the legal requirements, the compensation, and the like. The time line of the project includes a deadline for receiving the submissions on network platform 104, an expected date of completion of the project, the time line for receiving partially completed submissions, and the like. The various types of submissions expected for the project may be submissions that comply with the requirements of the project, the submissions that partially comply with any or all the requirements of the project, the submissions that comply with at least one of the requirements of the project, and the submissions that are substantially related to the requirements of the project. The submissions may be design reviews of the project, parts of computer programs, function modules, and the like.

In one embodiment of the invention, the requirements of the project include at least an indicative compensation for the project as well as an annotation. The indicative compensation is a proposed amount or an incentive to be given to sellers 106 by buyer 102. In another embodiment of the invention, buyer 102 may revise the indicative compensation periodically, on the basis of the compensation already given to seller 106 for partial submissions. The annotation includes a disclaimer that explains that the disbursement of the compensation for the project is at the discretion of buyer 102. Hence, the actual compensation to be given to sellers 106 is decided by buyer 102. Further, buyer 102 and sellers 106 do not enter any agreement to execute the project and determine the compensation to be made to the sellers for the project.

Buyer 102 submits the buy request through an interface on network platform 104. Examples of the interface include, but are not limited to, an html page, a web-based template, an email, and the like. In one embodiment of invention, the buy request may be uploaded on network platform 104 in the form of a notification, such that the notification may be directly viewed by sellers 106. In another embodiment of the invention, the buy request may be uploaded on network platform 104, such that separate notifications are sent to sellers 106. In yet another embodiment of the invention, the administrator of network platform 104 may identify sellers 106 and establish a communication channel between buyer 102 and sellers 106.

The buy request is submitted on network platform 104 by buyer 102, to inform sellers 106 about the project. In response to the buy request, sellers 106 may submit various submissions for the project within the given time line.

At 204, buyer 102 accepts the submissions submitted by sellers 106 on network platform 104. In one embodiment of the invention, buyer 102 may accept the submissions by accessing network platform 104. In another embodiment of the invention, buyer 102 may accept the submissions by receiving them from network platform 104 by an email. In an alternative embodiment of the invention, buyer 102 may directly accept the submissions from sellers 106. In yet another embodiment of the invention, sellers 106 may not provide any submission for the project; they may only provide an indication to another seller, a freely available submission, and the like.

The submissions are provided by sellers 106 on the basis of the buy request made by the buyer for the project and compliance with the requirements of the project.

In one embodiment of the invention, the submissions may be substantially related to the requirements of the project. Sellers 106 may submit a previously prepared submission that is related to the requirements of the project. The previously prepared submissions may also be modified to comply with the requirements of the project, and thereafter submitted to fully or partially comply with the requirements.

The submissions are submitted by sellers 106 through the interface on network platform 104. In various embodiments of the invention, the submissions are required to be submitted within the time line provided in the requirements.

At 206, buyer 102 accepts the evaluation of the submissions from evaluator 108. In one embodiment of the invention, buyer 102 accepts the evaluations from evaluator 108 through network platform 104. The evaluations are prepared by evaluator 108 for the submissions, based on their compliance with the requirements, the quality of the submissions, the time taken to provide the submissions, the profile of buyer 102, and the like.

At 208, buyer 102 determines the compensation for the project on the basis of the submissions. The compensation for the submissions are given to sellers 106 by buyer 102. The disbursement of the compensation to sellers 106 is based on the discretion of buyer 102. In one embodiment of the invention, buyer 102 may not provide any compensation to sellers 106 if it is found that the submissions do not to comply with the requirements.

In various embodiments of the invention, buyer 102 determines the compensation for the project on the basis of the submissions and evaluations. In one embodiment of the invention, buyer 102 determines the compensation on the basis of the utility of the submissions to complete the project. In another embodiment of the invention, buyer 102 may determine the compensation on the basis of the quality of the submissions, the time taken to submit the submissions, and the profile of sellers 106. In another embodiment of the invention, buyer 102 has a discussion with evaluator 108 to determine the compensation for sellers 106. In another embodiment of the invention, buyer 102 may also determine the compensation on the basis of the indicative compensation provided on the basis of the requirements of the project. In yet another embodiment of the invention, the compensation may not be same as the indicative compensation.

In various embodiments of the invention, the compensations are disbursed by using various financial intermediaries such as banks, webmasters, an escrow account on network platform 104, and the like. In one embodiment of the invention, the financial intermediaries may charge a percentage of the compensation as service charges for disbursing the compensation. The mode of disbursement of the compensation from buyer 102 to sellers 106 will be apparent to any person who is skilled in the art.

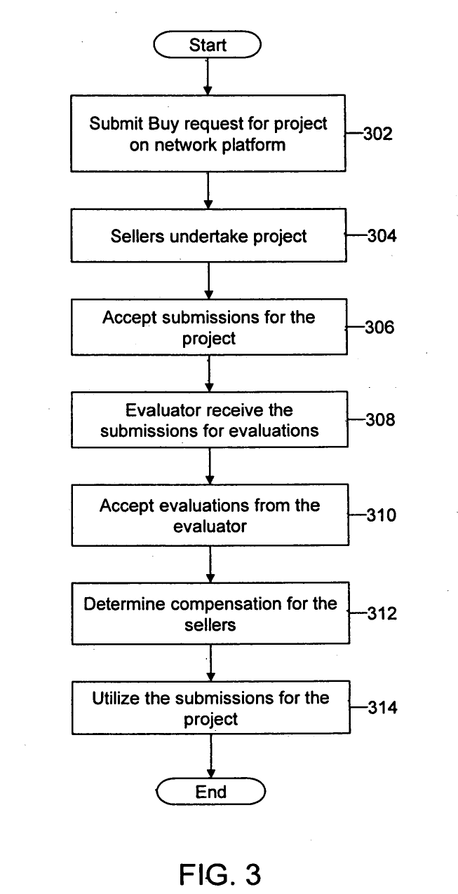

FIG. 3 is a flowchart depicting a method for managing the project on network platform 104, in accordance with another embodiment of the invention.

At 302, buyer 102 submits the buy request for the project on network platform 104. This has been explained in detail in conjunction with FIG. 2 at 202.

At 304, sellers 106 undertake the buy request for the project. In one embodiment of the invention, sellers 106 undertake the project, based on their capability to provide the submissions required for the project. In various embodiments of the invention, sellers 106 undertaking the project have the resources for executing the buy request, either completely or partially. The resources either comply with or are capable of complying with at least one of the requirements of the project. This enables sellers 106 to provide submissions within the time line provided in the requirements. Examples of the resources include, but are not limited to, technical expertise, past experience, employee strength, required software and hardware, machines, network infrastructure, skilled manpower, previously prepared submissions, prior experience, market recognition, and the like.

In one embodiment of the invention, sellers 106 prepare the submissions by utilizing the resources. In another embodiment of the invention, sellers 106 may directly provide the resources on network platform 104, in the form of the submissions for the project.

At 306, buyer 102 accepts the submissions submitted by sellers 106 on network platform 104. This has been explained in detail in conjunction with FIG. 2 at 204.

At 308, evaluator 108 receives the submissions submitted at network platform 104. Evaluator 108 provides the evaluations for the submissions to buyer 102 through network platform 104. In one embodiment of the invention, evaluator 108 receives the submissions by accessing network platform 104. In another embodiment of the invention, evaluator 108 receives the submissions from buyer 102.

In one embodiment of the invention, evaluation of the submissions is performed by evaluator 108 on the basis of the requirements of the project. In another embodiment of the invention, evaluator 108 evaluates the submissions, based on compliance with the requirements, the quality of the submissions, the time taken to submit the submissions, the effort required by sellers 106, the complexity of the project, and the like. In various embodiments of the invention, evaluations may be provided in the form of a text file, a report, a rating, an html format document, by word of mouth, and the like.

In one embodiment of the invention, evaluator 108 may enter a contract with buyer 102 or the administrator of network platform 104 to evaluate the submissions for the project. The contractual dealing of evaluator 108 will be apparent to any person who is skilled in the art.

At 310, buyer 102 accepts the evaluation for the submissions from evaluator 108. Thereafter, at 312, buyer 102 determines the compensation for the project on the basis of the submissions. This has been explained in detail in conjunction with FIG. 2 at 206 and 208.

At 314, buyer 102 utilizes the submissions for the project. If the submissions comply with all the requirements of the project, buyer 102 may use the submissions to execute the project. Even if the submissions comply with only some of the requirements of the project, buyer 102 may use them to execute the project. Buyer 102 may modify the received submissions and utilize them to execute the project. In one embodiment of the invention, buyer 102 may utilize a submission that was submitted for another project. The submissions for various projects may be maintained at a storage location, and be utilized for future projects. The storage location may be a database, a memory location, and the like.

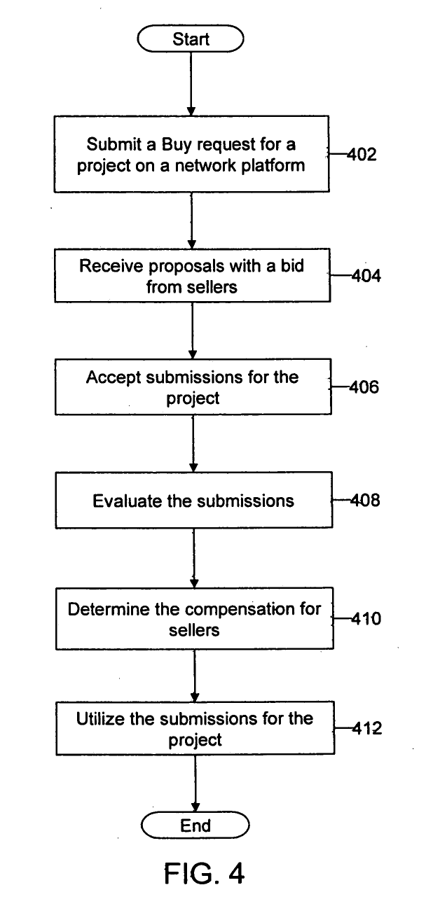

FIG. 4 is a flowchart depicting a method for managing the project on network platform 104, in accordance with another embodiment of the invention.

At 402, buyer 102 submits the buy request for the project on network platform 104. Buyer 102 includes the requirements of the project in the buy request. Examples of the requirements include, but are not limited to, the technical domain, the details, the objective, the time line, the type of submission expected, and the legal requirements of the project, the compensation for the project, and the like. In one embodiment of the invention, the requirements include proposals for the project. Buyer 102 submits the buy request on network platform 104 through an interface on network platform 104.

The buy request is submitted on network platform 104 by buyer 102 to inform sellers 106 about the project. In response to the buy request, sellers 106 may submit various proposals for the project.

At 404, buyer 102 receives the proposals for the project from sellers 106. In one embodiment of the invention, the proposals are received by buyer 102 through network platform 104. A proposal includes one or more bids to undertake the project, the proposed time line for providing submissions for the project, a brief overview of the infrastructure of sellers 106 to prepare the submissions, the proposed methodology for preparing the submissions, the way the submissions are presented, and the like.

In one embodiment of the invention, the bid may be an amount or an incentive expected from buyer 102 by sellers 106 as compensation for the submissions. The bid may depend on the infrastructure of sellers 106, the effort required to prepare the submissions, the budget of any similar type of projects performed previously, competition among the sellers, the complexity of the project, the geographical proximity, and the like. In another embodiment of the invention, sellers 106 may revise the bid in the event of a disagreement between buyer 102 and sellers 106. In yet another embodiment of the invention, buyer 102 may organize an auction on network platform 104 to receive and accept the bids from sellers 106.

Based on the proposals and the bid, buyer 102 and sellers 106 enter an agreement for the project. In various embodiments of the invention, the agreement is a legally binding contract with clauses on which buyer 102 and sellers 106 mutually agree. In one embodiment of the invention, the agreement is signed by buyer 102 and sellers 106 before the submissions for the project are prepared. In various embodiments of the invention, an agreement is drawn between buyer 102 and sellers 106 for projects of a relatively long duration. In another embodiment of the invention, a template for the agreement may be provided on network platform 104. The agreement may include the time line for submitting the submissions on network platform 104, the time line for submitting partial submissions, the type of submissions to be provided by sellers 106, the estimated compensation for the project, the invoicing details of the project, the mode by which sellers 106 will be provided compensation by buyer 102, and the like.

In various embodiments of the invention, the estimated compensation for the project may be decided on the basis of the utility of the submissions for completing the project, the market recognition of sellers 106, the requirements of the project, and the like.

At 406, buyer 102 accepts the submissions submitted by sellers 106 on network platform 104. These submissions comply with the requirements of the project and are provided by sellers 106 on the basis of their agreement with the buyer. In one embodiment of the invention, buyer 102 may accept the submissions by accessing network platform 104. In another embodiment of the invention, buyer 102 may accept the submissions by receiving the submissions from network platform 104 through an email.

Sellers 106 submit the submissions on network platform 104 through the interface on network platform 104. Sellers 106 are expected to submit the submissions on network platform 104, on the basis of the time line specified in the agreement.

At 408, buyer 102 evaluates the submissions provided by sellers 106. Buyer 102 plays the role of evaluator 108, as described in FIG. 2. The submissions are evaluated on the basis of the requirements of the project. In one embodiment of the invention, the submissions are evaluated on the basis of their compliance with the requirements of the project, the quality of the submissions, the time taken to provide the submissions, the profile of buyer 102, and the like. Buyer 102 evaluates whether the submissions are in line with the clauses of the agreement. In another embodiment of the invention, buyer 102 may ask sellers 106 to revise the submissions, if the submissions are not found to be in line with the clauses included in the agreement.

At 410, buyer 102 determines the compensation for the project on the basis of the submissions and the agreement. The compensation is given to sellers 106 by buyer 102 in response to the submissions. In one embodiment of the invention, the compensation is given in parts to sellers 106 if they provide partial submissions for the project. In various embodiments of the invention, the compensations are disbursed by using various financial intermediaries such as banks, webmasters, an escrow account on network platform 104, and the like. In another embodiment of the invention, financial intermediaries may charge a percentage of the compensation as service charges to provide the compensation. The mode of disbursement of the compensation to sellers 106 from buyer 102 will be apparent to any person who is skilled in the art.

At 412, buyer 102 utilizes the submissions for to execute the project.

In one embodiment of the invention, sellers 106 may enter an agreement with buyers 102, even if they have already undertaken the project.

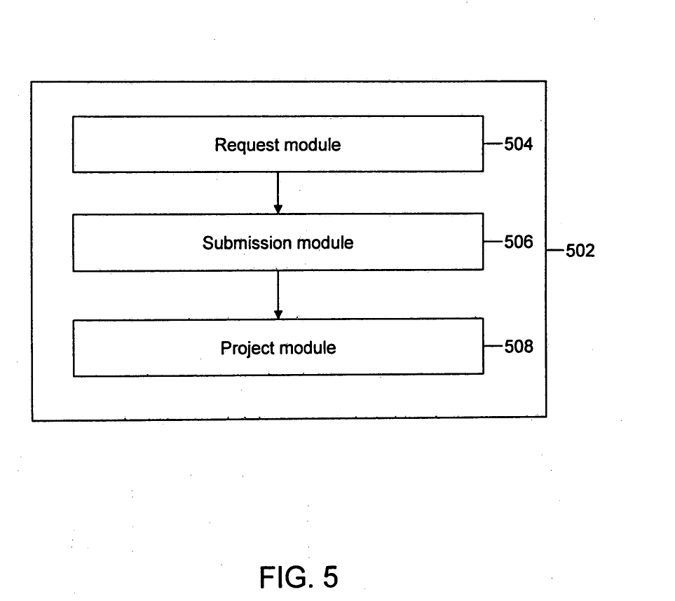

FIG. 5 is a block diagram illustrating the functional modules of a system 502, in accordance with one embodiment of the invention. System 502 includes a request module 504, a submission module 506 and a project module 508.

System 502 enables the management of projects through network platform 104. Buyer 102 submits a buy request for a project on system 502 through request module 504. Request module 504 is configured to provide the buy request on network platform 104. In response to the buy request, sellers 106 provide the submissions for the project, on the basis of the buy request, at submission module 506. The submissions are then provided to buyer 102 by project module 508. Buyer 102 may utilize the submissions to complete the project. Furthermore, buyer 102 determines the compensation for sellers 106, on the basis of the submissions.

Request module 504 is configured to provide the buy request for the project on network platform 104. Request module 504 accepts the buy request from buyer 102. The buy request includes the requirements of the project. In various embodiments of the invention, examples of the requirements include, but are not limited to, the technical domain, details, objective and time lines of the project, the type of submissions expected for the project, the legal requirements, and the like. In one embodiment of the invention, the requirements also include at least an indicative compensation for the project and an annotation. The annotation includes a disclaimer that explains that disbursement of the compensation for the project is at the discretion of buyer 102. In another embodiment of the invention, the requirements include proposals for the project.

In an embodiment of the invention, request module 504 accepts the buy request for the project from buyer 102 through an interface on network platform 104, and thereafter uploads it on network platform 104. In another embodiment of the invention, request module 504 uploads the buy request in the form of a notice on network platform 104, such that the notice may be directly viewed by seller 106. In yet another embodiment of the invention, request module 504 uploads the buy request by sending a separate notification to sellers 106.

Submission module 506 is configured to receive the submissions for the project from sellers 106. These submissions comply with the requirements of the project. In one embodiment of the invention, the submissions comply with all the requirements of the project. In another embodiment of the invention, the submissions partially comply with any or all the requirements of the project. In another embodiment of the invention, the submissions comply with at least one of the requirements of the project. In yet another embodiment of the invention, the submissions are substantially related to the requirements of the project.

In various embodiments of the invention, sellers 106 have resources to provide the submissions for the project. The resources comply with at least one of the requirements of the project. Examples of the resources include, but are not limited to, technical expertise, past experience, employee strength, required software and hardware, machines, network infrastructure, skilled manpower, previously prepared submissions, prior experience, market recognition, and the like. In one embodiment of the invention, sellers 106 prepare the submissions by utilizing the resources. These submissions are then submitted at submission module 506. In another embodiment of the invention, sellers 106 directly provide the resources on network platform 104 as the submissions for the project.

In one embodiment of the invention, submission module 506 receives the submissions for the project from sellers 106 through an interface on network platform 104.

In one embodiment of the invention, submission module 506 receives the submissions on the basis of the agreement between buyer 102 and sellers 106. Buyer 102 and sellers 106 enter the agreements on the basis of the proposal for the project provided by sellers 106 to buyer 102 in response to the buy request for the project.

Project module 508 receives the submissions from submission module 506 and is configured to provide the submissions to buyer 102. In various embodiments of the invention, project module 508 provides the submissions to buyer 102 by various means, such as uploading the submission on a secured web account controlled by buyer 102, sending the submissions through an email, and the like. Thereafter, buyer 102 utilizes the submissions to execute the project.

In various embodiments of the invention, the modules of system 602 may be implemented in the form of software, hardware, firmware, or combinations thereof.

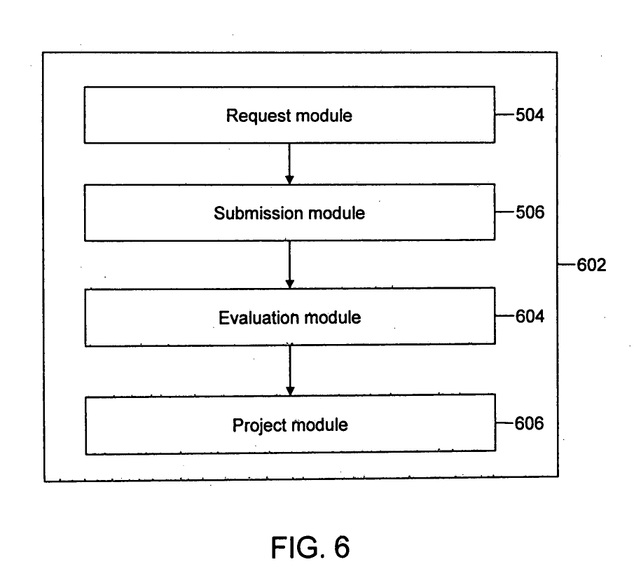

FIG. 6 is a block diagram illustrating the functional modules of a system 602, in accordance with another embodiment of the invention. The system 602 includes request module 504, submission module 506, an evaluation module 604 and a project module 606.

System 602 enables management of the projects through network platform 104. Buyer 102 submits the buy request for the project on system 602 through request module 504. Request module 504 is configured to make the buy request on network platform 104. In response to the buy request for the project, sellers 106 provide the submissions for the project, on the basis of the buy request, at submission module 506. The submissions are evaluated by evaluator 108. Evaluator 108 provides the evaluations for the submissions at evaluation module 604. Project module 606 then provides the submissions and the evaluation to buyer 102. Buyer 102 may utilize the submissions for the project. Furthermore, buyer 102 determines the compensation for sellers 106 on the basis of the submissions.

Evaluation module 604 is configured to receive the evaluation for the submissions from evaluator 108. In one embodiment of the invention, evaluator 108 receives the submissions from submission module 506 by accessing network platform 104. In yet another embodiment of the invention, evaluator 108 receives the one or more submissions directly from buyer 102.

Evaluator 108 evaluates the submissions on the basis of the requirements of the project. Further, evaluator 108 prepares the evaluation and provides at evaluation module 604. In various embodiments of the invention, the evaluation may be in the form of a text file, a report, a rating, an html format document, by word of mouth, and the like. Evaluator 108 then uploads the evaluation at evaluation module 604.

In one embodiment of the invention, evaluation module 604 receives the evaluation from evaluator 108 through an interface on network platform 104.

Project module 606 is configured to provide the submissions and evaluation to buyer 102. Project module 606 receives the submissions from submission module 506 and the evaluation from evaluation module 604. In various embodiments of the invention, project module 606 provides the submissions and evaluation to buyer 102 by various means, such as uploading the submissions and the evaluation on a secure web account controlled by buyer 102, sending them through an email, and the like.

In various embodiments of the invention, the modules of system 602 may be implemented in the form of software, hardware, firmware, or combinations thereof.

Various embodiments of the invention provide a number of advantages. In accordance with various embodiments of the invention, a network platform enables a buyer to manage a project with minimum in-person interaction with the sellers. The network platform provides an easily accessible platform for exchanging knowledge and executing projects in a short time. The invention enables buyers to enhance the quality of the project by accepting submissions from various sellers. Further, the buyer is not required to initiate the project from scratch. The buyer can build on the existing knowledge.

Intra-organizational synergies can be achieved by managing the projects. The invention also decreases the cost of the project, since the initial investment made by the buyer is considerably reduced. The skills and talent of the sellers can be recognized on the network platform, since their voluntary attempts are brought to the fore in the method of the invention. The invention enables automated checking and integration of the requirements of the projects.

The invention also enables the interaction of buyers and sellers across different geographical locations over the network platform, thereby providing access to global human resources and markets. Geographically dispersed people, resources, competencies and similar projects can be easily accessed. The invention enables effective and optimized project management at a reduced cost and execution time, and high-quality standards.

The computer system comprises a computer, an input device, a display unit and the Internet. The computer comprises a microprocessor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions into the computer system. The computer system also includes a communication unit, which enables the computer to connect to other databases and the Internet through an I/O interface. The communication unit enables the transfer and reception of data from other databases. The communication unit may include a modem, an Ethernet card, or any similar device that enables the computer system to connect to databases and networks such as LAN, MAN, WAN and the Internet. The computer system facilitates inputs from a user through an input device that is accessible to the system through an I/O interface.

To process input data, the computer system executes a set of instructions that is stored in one or more storage elements. The storage elements may hold data or other information as desired, and may be in the form of an information source or a physical memory element in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. Processing of input data by the processing machine may be in response to users' commands, the result of previous processing, or a buy request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

1. A method for managing a project on a network platform, the method comprising:
a. submitting a buy request for the project on the network platform, the buy request being submitted by a buyer, the buy request comprising a plurality of requirements of the project, the plurality of requirements comprising at least an indicative compensation for the project and an annotation, the annotation explaining that disbursement of one or more compensations for the project is up to the discretion of the buyer;
b. accepting one or more submissions for the project from one or more sellers, wherein the one or more submissions are submitted on the network platform by the one or more sellers, the one or more submissions complying with one or more of the plurality of requirements;
c. accepting one or more evaluations for the one or more submissions from an evaluator, the evaluator evaluating the one or more submissions on the basis of the plurality of requirements; and
d. determining the one or more compensations for the project, the one or more compensations for the project being determined by the buyer on the basis of the one or more submissions and the one or more evaluations, the one or more compensations being given to the one or more sellers.

2. The method according to claim 1, wherein the network platform is a portal hosted on a server.

3. The method according to claim 1 further comprising storing the one or more submissions, the one or more submissions being stored by the buyer.

4. The method according to claim 1 further comprising utilizing a submission accepted for another project, the submission being utilized by the buyer for the project.

5. The method according to claim 1, wherein the plurality of requirements comprise one or more time lines for submitting the one or more submissions by the one or more sellers on the network platform.

6. The method according to claim 1, wherein at least one of the plurality of requirements is a substantially related submission of another project, the substantially related submission being submitted as a submission for the project.

7. The method according to claim 1, wherein the one or more compensations are further determined on the basis of the indicative compensation.

8. The method of claim 1, wherein each of the one or more sellers have at least one resource, the at least one resource complying with at least one of the plurality of requirements, the one or more sellers utilizing the at least one resource for submitting the one or more submissions.

9. A method for managing a project on a network platform, the method comprising:
a. submitting a buy request for the project on the network platform, the buy request being submitted by a buyer, the buy request comprising a plurality of requirements of the project;
b. receiving one or more proposals for the project from one or more sellers, the one or more proposals comprising one or more bids for the project, the buyer arriving at one or more agreements with the one or more sellers based on the one or more proposals;
c. accepting one or more submissions for the project from the one or more sellers, wherein the one or more submissions are submitted on the network platform by the one or more sellers, each of the one or more sellers having at least one resource, the at least one resource complying with at least one of the plurality of requirements, each of the one or more sellers utilizing the at least one resource in submitting the one or more submissions for the project, the one or more submissions complying with one or more of the plurality of requirements;
d. evaluating the one or more submissions, the one or more submissions being evaluated by the buyer on the basis of the plurality of requirements; and
e. determining the one or more compensations for the project, the one or more compensations for the project being determined by the buyer on the basis of the one or more submissions and the one or more agreements, the one or more compensations being given to the one or more sellers.

10. The method according to claim 9, wherein the network platform is a portal hosted on a server.

11. The method according to claim 9 further comprising storing the one or more submissions, the one or more submissions being stored by the buyer.

12. The method according to claim 9 further comprising utilizing a submission accepted for another project, the submission being utilized by the buyer for the project.

13. The method according to claim 9, wherein the plurality of requirements comprise one or more time lines for submitting the one or more submissions by the one or more sellers on the network platform.

14. A system for managing a project on a network platform, the system comprising:
a. a request module configured for providing a buy request for the project on the network platform, wherein the buy request comprises a plurality of requirements of the project, the buy request being submitted by the buyer on the request module;
b. a submission module configured for receiving one or more submissions for the project from one or more sellers, wherein the one or more submissions comply with at least one of the plurality of requirements; and
c. a project module configured for providing the one or more submissions to the buyer, wherein the buyer utilizes the one or more submissions for the project, wherein the buyer determines one or more compensations for the project on the basis of the one or more submissions, the one or more compensations for the project being given to the one or more sellers.

15. The system according to claim 14, wherein the plurality of requirements comprise at least an indicative amount and an annotation, the annotation explaining that disbursement of the one or more compensations for the project is up to the discretion of the buyer.

16. The system according to claim 14 further comprising an evaluation module configured for receiving one or more evaluations for the one or more submissions submitted for the project at the submission module, the one or more evaluations being prepared by an evaluator, the evaluator evaluating the one or more submissions on the basis of the plurality of requirements.

17. The system according to claim 16, wherein the project module is configured for providing the one or more evaluations to the buyer, wherein the buyer further determines the one or more compensations on the basis of the one or more evaluations.

18. The system according to claim 14, wherein the submission module receives the one or more submissions on the basis of one or more agreements between the buyer and the one or more sellers, the one or more agreements being made with the buyer on the basis of one or more proposals provided by the one or more sellers.

19. The system according to claim 14, wherein each of the one or more sellers have at least one resource, the at least one resource complying with at least one of the plurality of requirements, the one or more sellers utilizing the at least one resource for submitting the one or more submissions.

20. A computer program product for use with a computer, the computer program product comprising a computer usable medium having a computer readable program code embodied therein for managing a project on a network platform, the computer readable program code performing:
a. receiving a buy request for the project from a buyer, the buy request comprising a plurality of requirements of the project;
b. providing the buy request on the network platform;
c. receiving one or more submissions for the project from one or more sellers, the one or more submissions complying with at least one of the plurality of requirements;
d. providing the one or more submissions to the buyer for the project.

21. The computer program product according to claim 20, wherein the plurality of requirements comprise at least an indicative amount and an annotation, the annotation explaining that disbursement of one or more compensations for the project is up to the discretion of the buyer.

22. The computer program product according to claim 20, wherein the computer readable program code further performs accepting one or more evaluations from an evaluator, the evaluator evaluating the one or more submissions based on the plurality of requirements.

23. The computer program product according to claim 22, wherein the computer readable program code further performs providing the one or more evaluations to the buyer.

24. The computer program product according to claim 20, wherein the computer readable program code further performs receiving the one or more submissions from the one or more sellers on the basis of one or more agreements between the buyer and the one or more sellers, the one or more agreements being made with the one or more sellers on the basis of one or more proposals provided by the one or more sellers.

25. The computer program product according to claim 20, wherein each of the one or more sellers have at least one resource, the at least one resource complying with at least one of the plurality of requirements, the one or more sellers utilizing the at least one resource for submitting the one or more submissions.
